(19) United States
(12) Patent Application Publication
(10) Pub. No.: US 2026/0060201 A1
(43) Pub. Date: Mar. 5, 2026

(54) FOLDING CART FRAME AND PET CART PROVIDED WITH CART FRAME

(71) Applicant: Wuyi Focean Import and Export Co., Ltd., Jinhua (CN)

(72) Inventor: Fuyun LIU, Jinhua (CN)

(73) Assignee: Wuyi Focean Import and Export Co., Ltd., Jinhua (CN)

(21) Appl. No.: 18/903,395

(22) Filed: Oct. 1, 2024

(30) Foreign Application Priority Data
Sep. 2, 2024 (CN) 2024112200661

(51) Int. Cl. A01K 1/02; B62B 3/00; B62B 3/02; B62B 5/06

(52) U.S. Cl. CPC A01K 1/0245; B62B 3/004; B62B 3/02; B62B 5/067

(57) ABSTRACT

The present invention discloses a folding cart frame and a pet cart provided with the folding cart frame, including a cart frame body, a wheel body assembly, a bottom frame structure, a first side frame structure, a second side frame structure, a third side frame structure, and a fourth side frame structure, where the third side frame structure includes a third side frame member connected to the first side frame structure and the second side frame structure and a first canopy frame member, and the fourth side frame structure includes a fourth side frame member connected to the first side frame structure and the second side frame structure and a second canopy frame member.

### CROSS-REFERENCE TO RELATED APPLICATIONS

The application claims priority to Chinese patent application No. 2024112200661, filed on Sep. 2, 2024, the entire contents of which are incorporated herein by reference.

### TECHNICAL FIELD

The present invention relates to the field of carts, and in particular, to a folding cart frame and a pet cart provided with the cart frame.

### BACKGROUND

Nowadays, there are a wide variety of carts on the market, which can be divided into a pet cart, a baby stroller, a camping cart, and the like according to uses. In recent years, as people's living standards continue to improve, more and more people begin to raise pets and choose to use the pet cart to carry the pet out.

In the prior art, a utility model patent (publication No. CN220465530U) of a pet cart frame and a pet cart is disclosed. The pet cart frame thereof includes a frame body and a cart wheel pivotally connected to a lower end of the frame body, cloth is wrapped on the frame body fully, the frame body and the cloth are combined to form an accommodation cavity configured to load a pet, a front end of the accommodation cavity is provided with an opening, and the pet may enter or exit the frame body from the opening. According to the pet cart frame in the technical solution, due to the short frame body thereof, space in the accommodation cavity is short, so that the pet cart frame is not suitable for loading some pets with high bodies.

### SUMMARY

For the deficiencies in the prior art, the present invention provides a folding cart frame and a pet cart provided with the folding cart frame, which can increase a height of placement space of a pet, so that movement space of the pet in the cart is higher, and some pets with high bodies are suitable to be loaded. In addition, occupied space after folding is small, thereby facilitating carrying out and storing.

A folding cart frame provided in the present invention has a folded state and an unfolded state and includes a cart frame body and a wheel body assembly configured to drive the cart frame body to move, where the cart frame body includes: a bottom frame structure, including at least two bottom frame members arranged along a length direction of the bottom frame structure in sequence, where two adjacent bottom frame members are rotatably connected, and the two adjacent bottom frame members are folded or unfolded through mutual rotation; a first side frame structure and a second side frame structure that are respectively arranged on two sides of the bottom frame structure along the length direction of the bottom frame structure, where the first side frame structure and the second side frame structure respectively include at least one group of two crossed rod members that are arranged in a mutually crossed manner and that are rotatably connected, and the two crossed rod members are folded or unfolded through mutual rotation; and a third side frame structure and a fourth side frame structure that are respectively arranged on the two sides of the bottom frame structure along a width direction of the bottom frame structure, where the third side frame structure includes a third side frame member connected between one end of the first side frame structure and one end of the second side frame structure and a first canopy frame member rotatably connected to an upper portion of the third side frame member, the first canopy frame member is folded by flipping outward relative to the third side frame member, the fourth side frame structure includes a fourth side frame member connected between the other end of the first side frame structure and the other end of the second side frame structure and a second canopy frame member rotatably connected to an upper portion of the fourth side frame member, the second canopy frame member is folded by flipping outward relative to the fourth side frame member, the first canopy frame member and the second canopy frame member form a support structure configured to mount and support a canopy in an unfolded state, and the first canopy frame member, the second canopy frame member, and the bottom frame member are arranged in a stacking manner in a folded state.

Preferably, the first canopy frame member and the third side frame member, and the second canopy frame member and the fourth side frame member are respectively connected through a first connecting structure, the first connecting structure includes a connecting member disposed on the third side frame member or the fourth side frame member and a limiting member connected to the connecting member, the connecting member is rotatably connected to the first canopy frame member or the second canopy frame member through a first connecting shaft, a first limiting surface is formed on one side, away from the first side frame structure and the second side frame structure, on the limiting member, an outer portion of the first limiting surface is provided with a rotation region allowing an end portion of the first canopy frame member or the second canopy frame member to be flipped around the first connecting shaft, and in the unfolded state, the first limiting surface abuts against a first abutting surface formed on the first canopy frame member or the second canopy frame member for limiting.

Preferably, an included angle between the first limiting surface and the third side frame member or the fourth side frame member is greater than 180° and less than 270°.

Preferably, a second limiting surface is further formed on one side, away from the first side frame structure and the second side frame structure, on the limiting member, the second limiting surface is arranged along a length direction of the third side frame member or the fourth side frame member, the second limiting surface abuts against a second abutting surface formed on the first canopy frame member or the second canopy frame member for limiting in the folded state, and the second abutting surface and the first abutting surface are oppositely arranged on two sides of the first connecting shaft.

Preferably, the second limiting surface is arranged below the first limiting surface and is connected to the first limiting surface through a rotating surface, the rotating surface is configured as a circular arc surface arranged coaxially with the first connecting shaft, and when the first canopy frame member or the second canopy frame member rotates around an axis of the first connecting shaft, the end portion thereof can move between the circular arc surface and the first connecting shaft.

Preferably, the third side frame member and the fourth side frame member respectively include a first column arranged on an end portion of the first side frame structure and a second column arranged on an end portion of the second side frame structure, the first canopy frame member and the second canopy frame member respectively include a first canopy column connected to the first column through one first connecting structure, a second canopy column connected to the second column through one first connecting structure, and a canopy connecting rod connected between the first canopy column and the second canopy column, the limiting member and the rotation region are arranged between the first column and the second column, the first canopy frame member and the second canopy frame member are arranged between the first column and the second column in the folded state, and the first column, the second column, the first canopy column, the second canopy column, the canopy connecting rod, and the bottom frame structure enclose to form an entrance-exit channel in the unfolded state.

Preferably, a bottom end of the connecting member is provided with a connecting groove in a sunken manner, the connecting groove is sleeved on the first column or the second column and is fixedly connected relative to the first column or the second column through a fastener, outer surfaces of the first canopy column and the second canopy column are configured as cylindrical surfaces, and the first limiting surface is configured as a circular arc concave surface arranged corresponding to the first canopy column or the second canopy column.

Preferably, included angles between the bottom frame structure and the third side frame member and the fourth side frame member are greater than 90° respectively, the first side frame structure and the second side frame structure respectively include a first crossed rod group connected to the third side frame member and a second crossed rod group connected to the fourth side frame member, the first crossed rod group includes a first crossed rod and a second crossed rod that are oppositely arranged in a crossing manner and that are rotatably connected with each other, the second crossed rod group includes a third crossed rod and a fourth crossed rod that are oppositely arranged in a crossing manner and that are rotatably connected with each other, one end of the first crossed rod is rotatably connected to a lower portion of the third side frame member, the other end thereof is rotatably connected to one end of the fourth crossed rod, one end of the second crossed rod is rotatably connected to an upper portion of the third side frame member through a first connecting strip, the other end thereof is rotatably connected to one end of the third crossed rod, the other end of the third crossed rod is rotatably connected to an upper portion of the fourth side frame member through a second connecting strip, and the other end of the fourth crossed rod is rotatably connected to a lower portion of the fourth side frame member; and
a support rod is connected between two second crossed rods and/or two third crossed rods, the bottom frame structure includes a first bottom frame member connected to the third side frame member and a second bottom frame member connected to the fourth side frame member, the first bottom frame member is rotatably connected to the second bottom frame member through a second connecting shaft, the second connecting shaft is arranged above the support rod, and the first bottom frame member and/or the second bottom frame member abut against an upper side of the support rod in the unfolded state.

Preferably, a handrail structure is mounted on one side, away from the third side frame member, on the fourth side frame member, and the handrail structure includes a third column and a fourth column that are oppositely arranged and a handrail rod whose two ends are rotatably connected to the third column and the fourth column respectively through a locking assembly; and
the third column and the fourth column are respectively connected to the fourth side frame member through a second connecting structure, the second connecting structure includes a mounting member that is fixedly connected relative to the fourth side frame member and a connecting cylinder connected to one side, away from the third side frame member, on the mounting member, the third column and the fourth column are respectively sleeved on a corresponding connecting cylinder and telescopically connected to the connecting cylinder, and the third column and the fourth column are respectively connected to the connecting cylinder in a positioning manner through a positioning assembly in the unfolded state.

A pet cart provided in the present invention includes a folding cart frame described above and a cloth cover structure covering a first side frame structure, a second side frame structure, a third side frame structure, and a fourth side frame structure, where the cloth cover structure includes a door cloth member arranged corresponding to the third side frame structure and/or the fourth side frame structure; and the cloth cover structure is provided with a first visible region arranged among the first side frame structure, a first canopy frame member, and a second canopy frame member, and/or the cloth cover structure is provided with a second visible region arranged among the second side frame structure, the first canopy frame member, and the second canopy frame member, and/or the cloth cover structure is provided with a third visible region arranged corresponding to the third side frame structure, and/or the cloth cover structure is provided with a fourth visible region arranged corresponding to the fourth side frame structure.

According to the folding cart frame provided in the present invention, the first canopy frame member and the second canopy frame member are disposed, so that when the folding cart frame is in the unfolded state, a support structure configured to mount and support a canopy can be formed through the first canopy frame member and the second canopy frame member, thereby greatly increasing a height of placement space of a pet. Therefore, movement space of the pet in the cart is higher, a large pet is allowed to sit in the cart and stand high, and especially some pets with high bodies are suitable to be loaded. In addition, the canopy can be mounted and supported on the support structure, thereby preventing rain, sun, and the like for the pet. In addition, when the folding cart frame is in the folded state, the first canopy frame member can be folded by flipping outward relative to the third side frame member, the second canopy frame member can be folded by flipping outward relative to the fourth side frame member, and the first canopy frame member, the second canopy frame member, and the bottom frame member are arranged in a stacking manner in the folded state, so that the folding cart frame can be placed horizontally after being folded. Stability of a placement state is good, and overall occupied space of the folding cart frame is reduced, thereby facilitating carrying out and storing.

Additional aspects and advantages of the present invention will be partially given in the following description, and will become apparent from the following description or be learned from the practice of the present invention.

### BRIEF DESCRIPTION OF THE DRAWINGS

The accompanying drawings described herein are intended for further understanding of the present invention and constitute a part of the present application. Schematic embodiments of the present invention and descriptions thereof are used to explain the present invention, and do not constitute any inappropriate limitation on the present invention. In the accompanying drawing:

FIG. 1 is a schematic structural diagram 1 of a folding cart frame according to an embodiment of the present invention;

FIG. 2 is a schematic structural partial diagram of a folding cart frame in an unfolded state according to an embodiment of the present invention;

FIG. 3 is a schematic structural diagram of a first connecting structure according to an embodiment of the present invention;

FIG. 4 is a schematic structural partial diagram of a folding cart frame in a folded state according to an embodiment of the present invention;

FIG. 5 is an exploded view of a folding cart frame according to an embodiment of the present invention;

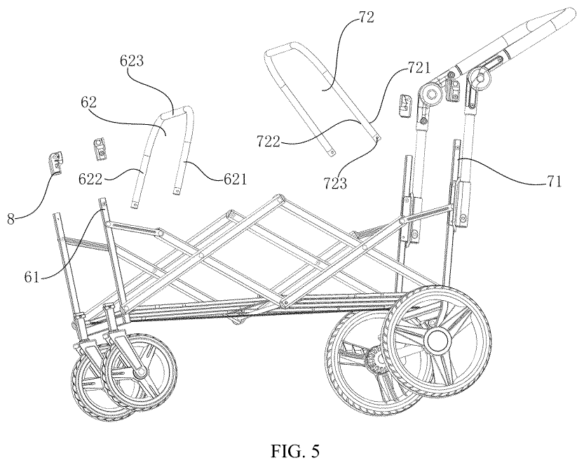

FIG. 6 is an exploded view of a locking assembly according to an embodiment of the present invention;

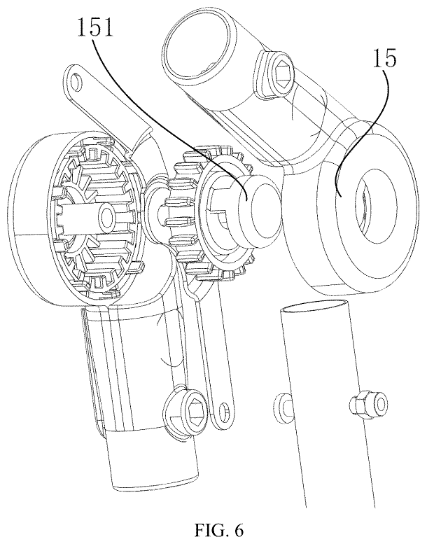

FIG. 7 is a schematic structural diagram of a handrail structure according to an embodiment of the present invention;

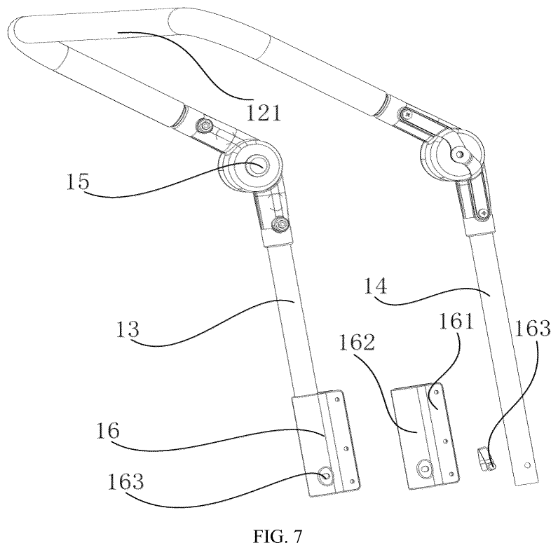

FIG. 8 is a schematic structural diagram 2 of a folding cart frame according to an embodiment of the present invention;

FIG. 9 is a schematic structural partial diagram 2 of a folding cart frame according to an embodiment of the present invention;

FIG. 10 is a partial enlarged view of a position A in FIG. 9;

FIG. 11 is a folded state diagram of a folding cart frame according to an embodiment of the present invention; and

FIG. 12 is a schematic structural diagram of a pet cart according to an embodiment of the present invention.

### DETAILED DESCRIPTION OF THE EMBODIMENTS

To make the purpose, technical solutions, and advantages of the embodiments of the present invention clearer, the following clearly and completely describes the technical solutions of the embodiments of the present invention with reference to the accompanying drawings of the embodiments of the present invention. Apparently, the described embodiments are some rather than all of the embodiments of the present invention. Based on the described embodiments of the present invention, all other embodiments obtained by those of ordinary skill in the art without making creative efforts shall fall within the scope of protection of the present invention.

In the description of the present invention, it should be understood that the orientations or positional relationships indicated by the terms “upper”, “lower”, “front”, “rear”, “left”, “right”, “top”, “bottom”, “inner”, “outer”, and the like are in accordance with those shown in the accompanying drawings, and are intended only for the convenience of describing the present invention and simplifying the description rather than for indicating or implying that the referred devices or elements must be provided with a particular orientation or constructed or operated in a particular orientation; and therefore, these terms should not be construed as limiting the present invention.

In the description of the present invention, it should be noted that, unless otherwise explicitly provided and limited, the terms “mounted”, “connected”, and “fixed” should be understood in a broad sense, for example, it may be a fixed connection, a detachable connection, or an integral connection; it may be a mechanical connection or an electrical connection; it may be a direct connection or an indirect connection through an intermediate medium; and it may be an internal communication between two elements. For those of ordinary skill in the art, the specific meanings of the above terms in the present invention can be understood based on specific situations.

In the present invention, unless otherwise expressly specified and defined, a first feature being “above” or “below” a second feature may include not only direct contact between the first and second features but also indirect contact between the first and second features via another feature between them. Furthermore, a first feature being “above” a second feature includes the first feature being directly above and diagonally above the second feature, or simply means that the first feature is higher in level than the second feature. Furthermore, a first feature being “below” a second feature includes the first feature being directly below and diagonally below the second feature, or simply means that the first feature is lower in level than the second feature.

Unless otherwise defined, the technical terms or scientific terms used herein shall have the same meaning as that commonly understood by a person of ordinary skill in the art of the present invention. As used herein, “first”, “second”, and the like used in the specification and the claims of the patent application of the present invention do not indicate any sequence, quantity, or importance, but are only used to distinguish different components. Similarly, similar words such as “one” or “a/an” do not indicate a quantity limitation, but indicate that there is at least one.

It should be noted that, in the following descriptions, a third side frame member is a front of a pet cart, and a face at which a handrail structure is located is a back of the pet cart.

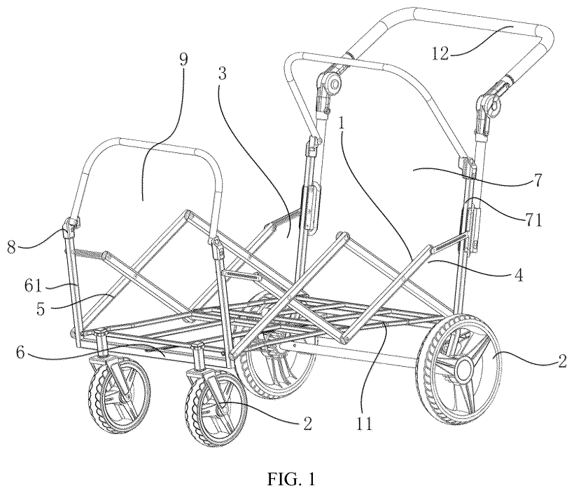

As shown in FIG. 1, as an embodiment of the present invention, a folding cart frame is provided, has a folded state and an unfolded state, and includes a cart frame body 1 and a wheel body assembly 2 configured to drive the cart frame body to move, where the cart frame body includes a bottom frame structure 11, a first side frame structure 4 and a second side frame structure 5 respectively arranged on two sides of the bottom frame structure 11 along a length direction of the bottom frame structure 11, and a third side frame structure 6 and a fourth side frame structure 7 respectively arranged on the two sides of the bottom frame structure 11 along a width direction of the bottom frame structure 11. The bottom frame structure 11 includes at least two bottom frame members arranged along the length direction of the bottom frame structure in sequence, two adjacent bottom frame members are rotatably connected, and the two adjacent bottom frame members are folded or unfolded through mutual rotation. Compared with a bottom frame structure 11 with a criss-cross structure on a bottom portion, the two bottom frame members are designed to have higher strength and stronger load capacities. The first side frame structure and the second side frame structure respectively include at least one group of two crossed rod members 42 that are arranged in a mutually crossed manner and that are rotatably connected, and the two crossed rod members 42 are folded or unfolded through mutual rotation. Storage space is reduced when a whole cart is not used through folding between the crossed rod members 42. The third side frame structure includes a third side frame member 61 connected between one end of the first side frame structure and one end of the second side frame structure and a first canopy frame member 62 rotatably connected to an upper portion of the third side frame member 61, and the first canopy frame member 62 is folded by flipping outward relative to the third side frame member 61. The fourth side frame structure 7 includes a fourth side frame member 71 connected between the other end of the first side frame structure and the other end of the second side frame structure and a second canopy frame member 72 rotatably connected to an upper portion of the fourth side frame member 71, and the second canopy frame member 72 is folded by flipping outward relative to the fourth side frame member 71. The first canopy frame member 62 and the second canopy frame member 72 are disposed, so that when the folding cart frame is in an unfolded state, a support structure configured to mount and support a canopy can be formed through the first canopy frame member 62 and the second canopy frame member 72, thereby greatly increasing a height of placement space of a pet. Therefore, movement space of the pet in the cart is higher, a large pet is allowed to sit in the cart and stand high, and especially some pets with high bodies are suitable to be loaded. In addition, the canopy can be mounted and supported on the support structure, thereby preventing rain, sun, and the like for the pet. In addition, when the folding cart frame is in a folded state, the first canopy frame member 62 can be folded by flipping outward relative to the third side frame member 61, the second canopy frame member 72 can be folded by flipping outward relative to the fourth side frame member 71, and the first canopy frame member 62, the second canopy frame member 72, and the bottom frame structure 11 are arranged in a stacking manner in the folded state, so that the folding cart frame can be placed horizontally after being folded. Stability of a placement state is good, and overall occupied space of the folding cart frame is reduced, thereby facilitating carrying out and storing.

As shown in FIG. 1 to FIG. 4, in some specific embodiments, the first canopy frame member 62 and the third side frame member 61, and the second canopy frame member 72 and the fourth side frame member 71 are respectively connected through a first connecting structure 8, the first connecting structure 8 includes a connecting member 81 disposed on the third side frame member 61 or the fourth side frame member 71 and a limiting member 82 connected to the connecting member, the connecting member 81 is rotatably connected to the first canopy frame member 62 or the second canopy frame member 72 through a first connecting shaft 723, a first limiting surface 821 is formed on one side, away from the first side frame structure and the second side frame structure, on the limiting member 82, an outer portion of the first limiting surface 821 is provided with a rotation region allowing an end portion of the first canopy frame member 62 or the second canopy frame member 72 to be flipped around the first connecting shaft 723, and in an unfolded state, the first limiting surface 821 abuts against a first abutting surface 721 formed on the first canopy frame member 62 or the second canopy frame member 72 for limiting. After abutting and limiting, the support structure formed through the first canopy frame member 62 and the second canopy frame member 72 fixes the first canopy frame member and the second canopy frame member, thereby improving structural stability. When the canopy is wrapped outside, the structure can bear a large impact, strengthen a wind resistance capacity, and cannot be blown down in bad weather.

In some specific embodiments, an included angle between the first limiting surface 821 and the third side frame member 6 or the fourth side frame member 7 is greater than 180° and is less than 270°, and particularly is between 210° and 240°, so that structural stability during unfolding can be ensured, an increase of space in the cart can be ensured, and it can be ensured that the first canopy frame member and the second canopy frame member may be integrally folded into the third side frame member and the fourth side frame member when being folded by flipping outward. When being unfolded, the first canopy frame member and the second canopy member can form an angle with a bottom surface of the bottom frame structure 11, so that the whole cart is of a hexagonal structure under a use state in which cloth is wrapped. After the cloth is wrapped on the whole cart, structural strength of the whole cart is increased and wind resistance strength is increased.

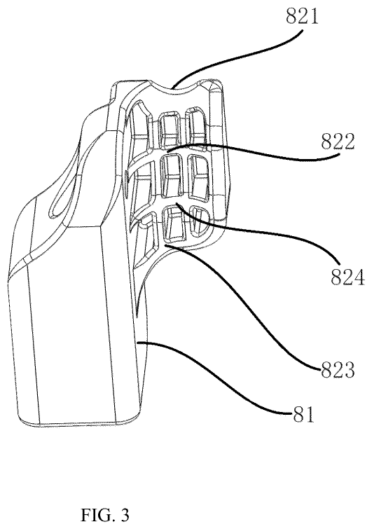

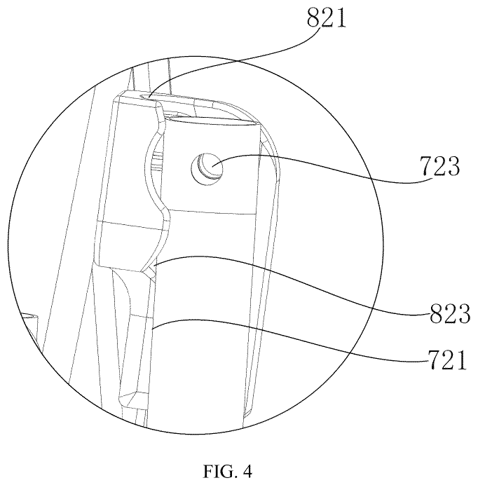

As shown in FIG. 3, in some specific embodiments, a second limiting surface 823 is further formed on one side, away from the first side frame structure and the second side frame structure, on the limiting member 82, and the second limiting surface 823 is arranged along a length direction of the third side frame member 6 or the fourth side frame member 7. As shown in FIG. 4, in the folded state, the second limiting surface 823 abuts against a second abutting surface 723 formed on the first canopy frame member 4 or the second canopy frame member 5 for limiting, to prevent the first canopy frame member 4 or the second canopy frame member 5 from being excessively rearward to be overlapped and clamped with the bottom frame structure 11, and the second abutting surface 723 and the first abutting surface 721 are oppositely arranged on two sides of the first connecting shaft 723.

As shown in FIG. 3, in some specific embodiments, the second limiting surface 823 is arranged below the first limiting surface 821 and is connected to the first limiting surface 821 through a rotating surface 824, the rotating surface 824 is configured as a circular arc surface arranged coaxially with the first connecting shaft, which can better support the first canopy frame member and the second canopy frame member compared to directly hollowing out according to a rotation range to increase strength of the limiting member. When the first canopy frame member 62 or the second canopy frame member 72 rotates around an axis of the first connecting shaft 723, the end portion thereof can move between the circular arc surface and the first connecting shaft 723, so that the first canopy frame member and the second canopy frame member are more labor-saving and easier to rotate.

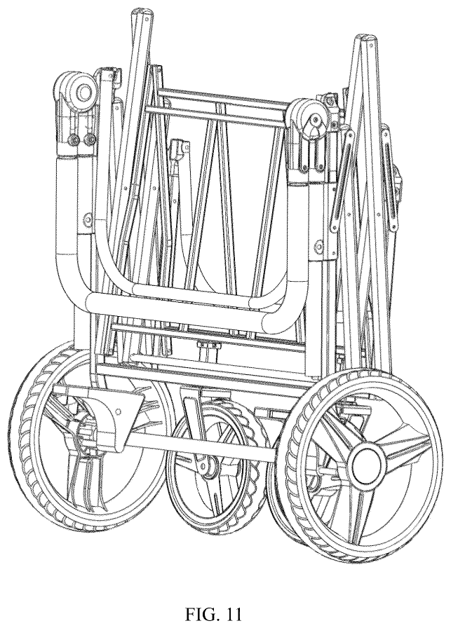

As shown in FIG. 1 and FIG. 11, in some specific embodiments, the third side frame member and the fourth side frame member respectively include a first column 41 arranged on an end portion of the first side frame structure 4 and a second column 51 arranged on an end portion of the second side frame structure 5, the first canopy frame member and the second canopy frame member respectively include a first canopy column 621 connected to the first column 41 through one first connecting structure 8, a second canopy column 622 connected to the second column 51 through one first connecting structure 8, and a canopy connecting rod 623 connected between the first canopy column 621 and the second canopy column 622, a limiting member 82 and the rotation region 822 are arranged between the first column 41 and the second column 51, and in the folded state, the first canopy frame member and the second canopy frame member are arranged between the first column 41 and the second column 51, so that the first canopy frame member and the second canopy frame member can be completely folded into the first column 41 and the second column 51 of the third side frame member and the fourth side frame member after being folded without occupying space. In the embodiment, the first canopy column 621 and the second canopy column 622 form the first canopy frame member and the second canopy frame member that are of U-shapes with the canopy connecting rod 623. A canopy surface structure of a U-shaped structure is simple, and has a larger contact area with a cloth cover, supports the cloth cover more stably, and is less likely to wear out the interior of the cloth cover compared with an H-shaped structure. In the unfolded state, the first column 41, the second column 51, the first canopy column 621, the second canopy column 622, the canopy connecting rod 623, and the bottom frame structure enclose to form an entrance-exit channel 9. From a front view, a U-shaped canopy and a rectangle formed by the first column 41 and the second column 51 are spliced into the large rectangular entrance-exit channel 9. The entrance-exit channel facilitates entering and exiting of the pet, and the pet may enter or exit the channel itself. In addition, due to additional internal space of the cart supported by the U-shaped canopy frame, a size of the entrance-exit channel 9 is increased accordingly, and the large pet may enter and exit the channel freely.

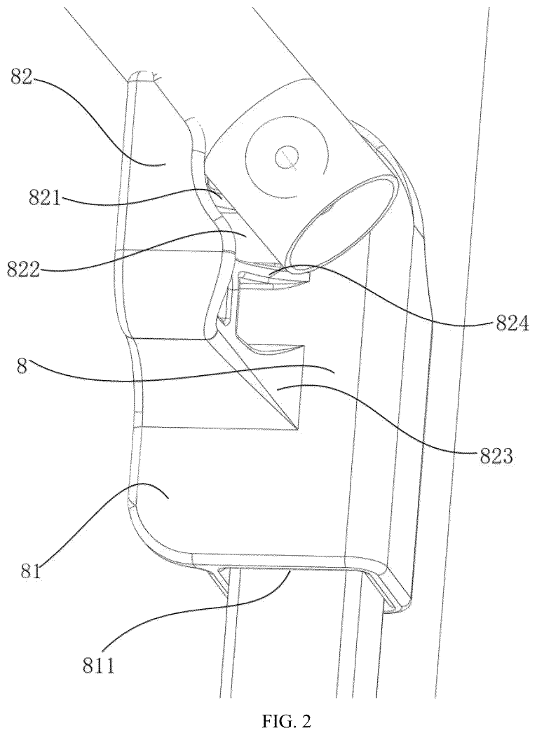

As shown in FIG. 2, in some specific embodiments, a bottom end of the connecting member is provided with a connecting groove 811 in a sunken manner, and the connecting groove 811 is sleeved on the first column 41 or the second column 51 and is fixedly connected relative to the first column 41 or the second column 51 through a fastener. Outer surfaces of the first canopy column 621 and the second canopy column 622 are configured as cylindrical surfaces, so that circular columns of the first canopy column 621 and the second canopy column 622 can be configured with the first limiting surface 821 as a circular arc concave surface arranged corresponding to the first canopy column 621 or the second canopy column 622. Therefore, an abutting area between the circular column and the circular arc concave surface is increased, and the circular column can better abut against the circular arc concave surface.

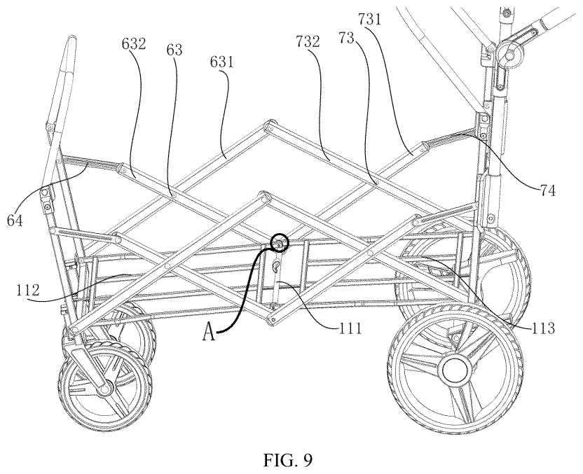

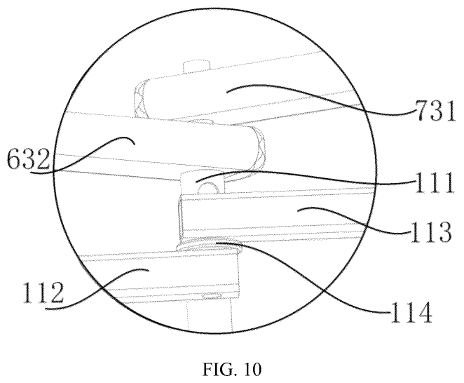

As shown in FIG. 9 and FIG. 10, in some specific embodiments, included angles between the bottom frame structure 11 and the third side frame member and the fourth side frame member are respectively greater than 90°, and particularly are greater than 90° and less than or equal to 120°, so that the internal space of the cart is more in line with a body structure of a dog and another pet and is more suitable for loading the pet. The first side frame structure and the second side frame structure respectively include a first crossed rod group 63 connected to the third side frame member 6 and a second crossed rod group 73 connected to the fourth side frame member 7, where the first crossed rod group 63 includes a first crossed rod 631 and a second crossed rod 632 that are oppositely arranged in a crossing manner and that are rotatably connected with each other, and the second crossed rod group 73 includes a third crossed rod 731 and a fourth crossed rod 732 that are oppositely arranged in a crossing manner and that are rotatably connected with each other. One end of the first crossed rod 631 is rotatably connected to a lower portion of the third side frame member 6, and the other end thereof is rotatably connected to one end of the fourth crossed rod 732. One end of the second crossed rod 632 is rotatably connected to an upper portion of the third side frame member 6 through a first connecting strip 64, and the other end thereof is rotatably connected to one end of the third crossed rod 731. The other end of the third crossed rod 731 is rotatably connected to an upper portion of the fourth side frame member 7 through a second connecting strip 74, and the other end of the fourth crossed rod 732 is rotatably connected to a lower portion of the fourth side frame member 7. Compared with folding and unfolding of a conventional folding cart with a fixed length of a crossed rod by extending or retracting a length of a column upward and downward, according to folding with matching of a plurality of rod groups, the folding is smoother and has higher structural strength by using the first connecting strip 64 and the second connecting strip 74. In the embodiment, a support rod 111 is connected between two second crossed rods 632 and two third crossed rods 731, and the bottom frame structure 11 includes a first bottom frame member 112 connected to the third side frame member 6 and a second bottom frame member 113 connected to the fourth side frame member 7, where the first bottom frame member 112 is rotatably connected to the second bottom frame member 113 through a second connecting shaft 114, and the second connecting shaft 114 is arranged above the support rod 111. In the unfolded state, the first bottom frame member 112 and/or the second bottom frame member 113 abut against an upper side of the support rod 111, and the second connecting shaft 114 makes a folding process more labor-saving and smoother. After the cloth is wrapped on the whole cart, bottom cloth may be wrapped above the first bottom frame member 112 and the second bottom frame member 113, and the bottom cloth is provided with a pull ring, so that the first bottom frame member 112 and the second bottom frame member 113 with two adjacent bottoms form a whole and may be folded and unfolded by using the pull ring. In addition, due to existence of the support rod 111, the bottom frame structure in the unfolded state has a stronger load capacity.

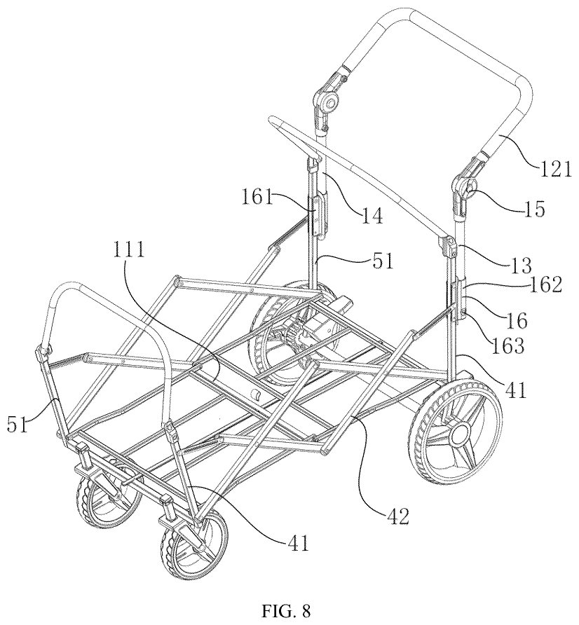

As shown in FIG. 8 and FIG. 9, in some specific embodiments, a handrail structure 12 is mounted on one side, away from the third side frame member 61, on the fourth side frame member 71, and the handrail structure 12 includes a third column 13 and a fourth column 14 that are oppositely arranged and a handrail rod 121 whose two ends are rotatably connected to the third column 13 and the fourth column 14 respectively through a locking assembly 15. The locking assembly 15 is fixed through engagement. Rotation buttons on the third column 13 and the fourth column 14 are pressed down simultaneously, and then an engaging member is pushed out of an engagement position, so that the handrail rod may rotate. After the handrail rod rotates to a required position, the rotation button 151 is released, and a spring in the locking assembly bounces the rotation button back to an original position, thereby facilitating rapid positioning after the handrail rod 121 is unfolded and folded. The third column and the fourth column are respectively connected to the fourth side frame member 71 through a second connecting structure 16, and the second connecting structure 16 includes a mounting member 161 that is fixedly connected relative to the fourth side frame member 71 and a connecting cylinder 162 connected to one side, away from the third side frame member, on the mounting member. The third column 13 and the fourth column 14 are respectively sleeved on a corresponding connecting cylinder 162 and are telescopically connected to the connecting cylinder 162. In the unfolded state, the third column 13 and the fourth column 14 are respectively connected to the connecting cylinder 162 in a positioning manner through a positioning assembly 163, which simply and efficiently copes with hand pushing heights of persons with various heights. In addition, in the folded state, a handrail can be folded to a lowest position, thereby reducing a length of a folded folding cart and facilitating storage and carrying.

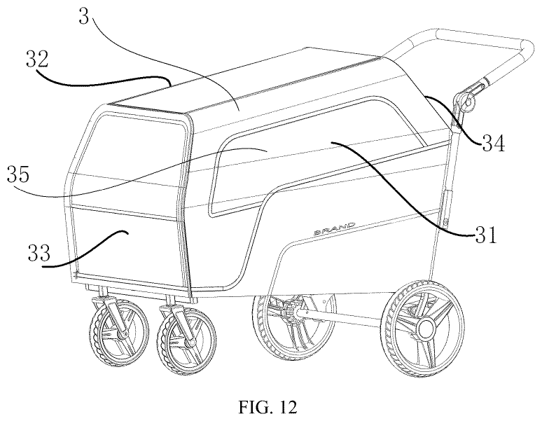

As shown in FIG. 12, as an embodiment 2 of the present invention, a pet cart is further provided. The pet folding cart includes the folding cart frame in the embodiment 1 and a cloth cover structure 3 covering the first side frame structure, the second side frame structure, the third side frame structure, and the fourth side frame structure. The cloth cover structure 3 includes a door cloth member, and the door cloth member may be arranged on both the third side frame structure 6 and the fourth side frame structure 7, or may be arranged on one of the third side frame structure 6 and the fourth side frame structure 7. All or part of structures of the door cloth member are separably connected to a surrounding cover through a zipper and another structure and are configured to form a door opening that is arranged corresponding to the entrance-exit channel 9 and that allows the pet to get on or off the cart after being separated from the surrounding cloth cover. The cloth cover structure 3 further includes an enclosure frame cloth member that is wrapped outside the bottom frame structure 11, the first side frame structure 4, and the second side frame structure 5 and a canopy cloth member that is wrapped between the enclosure frame cloth member and upper portions of two door cloth members. The canopy cloth member, the enclosure frame cloth member, and the two door cloth members are connected with each other and jointly cover the first side frame structure, the second side frame structure, the third side frame structure, and the fourth side frame structure fully. The canopy cloth member includes a canopy cloth member body and a canopy cloth member movable body. All or part of structures of the canopy cloth member movable body are separably connected to the canopy cloth member body through a zipper and another structure and are configured to form a non-canopy state after being separated from the canopy cloth member body, which are suitable for use under conditions that rain proofing and sun proofing are not needed and facilitate folding of the whole cart. The cloth cover structure 3 is provided with a first visible region 31 arranged among the first side frame structure 4, a first canopy frame member 62, and a second canopy frame member 72. The cloth cover structure may be provided with a second visible region 32 arranged among the second side frame structure 5, the first canopy frame member 62, and the second canopy frame member 72. The cloth cover structure may be provided with a third visible region 33 arranged corresponding to the third side frame structure 6. The cloth cover structure may be provided with a fourth visible region 34 arranged corresponding to the fourth side frame structure 7. In the embodiment, a shape of each visible region is configured as a trapezoidal structure, which has a relatively wide field of view and is convenient for the pet to observe the outside in the cart. Each visible region is configured to be of a gauze cart window structure, which has a certain air permeability and can ensure the pet smoothly breathes in the cart. In some other embodiments, all or part of the visible regions may also be configured to be of a circular shape, a parallelogrammic shape, a quadrate shape, a triangular shape, and another shape structure. All or part of the visible regions may also be configured to be of a transparent plate structure, a transparent plastic film structure, and another structure. These structures can be used for the pet to observe the outside in the cart.

Finally, it should be noted that the above embodiments are only used to illustrate the technical solutions of the present invention rather than limiting thereto. Although the present invention has been described in detail with reference to the foregoing embodiments, those of ordinary skill in the art should understand that the technical solutions recited in the foregoing embodiments may still be modified, or some of the technical features thereof may be replaced with equivalents. These modifications or replacements do not make the essence of the corresponding technical solution deviate from the scope of the technical solutions in the embodiments of the present invention.

In conclusion, the foregoing descriptions are merely preferred embodiments of the present invention, and all equivalent changes and modifications made according to the scope of the patent application of the present invention shall fall within the scope of the patent of the present invention.

What is claimed is:

1. A folding cart frame, having a folded state and an unfolded state, comprising a cart frame body and a wheel body assembly configured to drive the cart frame body to move, wherein the cart frame body comprises:
a bottom frame structure, comprising at least two bottom frame members arranged along a length direction of the bottom frame structure in sequence, wherein two adjacent bottom frame members are rotatably connected, and the two adjacent bottom frame members are folded or unfolded through mutual rotation;
a first side frame structure and a second side frame structure that are respectively arranged on two sides of the bottom frame structure along the length direction of the bottom frame structure, wherein the first side frame structure and the second side frame structure respectively comprise at least one group of two crossed rod members that are arranged in a mutually crossed manner and that are rotatably connected, and the two crossed rod members are folded or unfolded through mutual rotation; and
a third side frame structure and a fourth side frame structure that are respectively arranged on the two sides of the bottom frame structure along a width direction of the bottom frame structure, wherein the third side frame structure comprises a third side frame member connected between one end of the first side frame structure and one end of the second side frame structure and a first canopy frame member rotatably connected to an upper portion of the third side frame member, the first canopy frame member is folded by flipping outward relative to the third side frame member, the fourth side frame structure comprises a fourth side frame member connected between the other end of the first side frame structure and the other end of the second side frame structure and a second canopy frame member rotatably connected to an upper portion of the fourth side frame member, the second canopy frame member is folded by flipping outward relative to the fourth side frame member, the first canopy frame member and the second canopy frame member form a support structure configured to mount and support a canopy in an unfolded state, and the first canopy frame member, the second canopy frame member, and the bottom frame member are arranged in a stacking manner in a folded state.

2. The folding cart frame according to claim 1, wherein the first canopy frame member and the third side frame member, and the second canopy frame member and the fourth side frame member are respectively connected through a first connecting structure, the first connecting structure comprises a connecting member disposed on the third side frame member or the fourth side frame member and a limiting member connected to the connecting member, the connecting member is rotatably connected to the first canopy frame member or the second canopy frame member through a first connecting shaft, a first limiting surface is formed on one side, away from the first side frame structure and the second side frame structure, on the limiting member, an outer portion of the first limiting surface is provided with a rotation region allowing an end portion of the first canopy frame member or the second canopy frame member to be flipped around the first connecting shaft, and in the unfolded state, the first limiting surface abuts against a first abutting surface formed on the first canopy frame member or the second canopy frame member for limiting.

3. The folding cart frame according to claim 2, wherein an included angle between the first limiting surface and the third side frame member or the fourth side frame member is greater than 180° and less than 270°.

4. The folding cart frame according to claim 2, wherein a second limiting surface is further formed on one side, away from the first side frame structure and the second side frame structure, on the limiting member, the second limiting surface is arranged along a length direction of the third side frame member or the fourth side frame member, the second limiting surface abuts against a second abutting surface formed on the first canopy frame member or the second canopy frame member for limiting in the folded state, and the second abutting surface and the first abutting surface are oppositely arranged on two sides of the first connecting shaft.

5. The folding cart frame according to claim 4, wherein the second limiting surface is arranged below the first limiting surface and is connected to the first limiting surface through a rotating surface, the rotating surface is configured as a circular arc surface arranged coaxially with the first connecting shaft, and when the first canopy frame member or the second canopy frame member rotates around an axis of the first connecting shaft, the end portion thereof can move between the circular arc surface and the first connecting shaft.

6. The folding cart frame according to claim 2, wherein the third side frame member and the fourth side frame member respectively comprise a first column arranged on an end portion of the first side frame structure and a second column arranged on an end portion of the second side frame structure, the first canopy frame member and the second canopy frame member respectively comprise a first canopy column connected to the first column through one first connecting structure, a second canopy column connected to the second column through one first connecting structure, and a canopy connecting rod connected between the first canopy column and the second canopy column, the limiting member and the rotation region are arranged between the first column and the second column, the first canopy frame member and the second canopy frame member are arranged between the first column and the second column in the folded state, and the first column, the second column, the first canopy column, the second canopy column, the canopy connecting rod, and the bottom frame structure enclose to form an entrance-exit channel in the unfolded state.

7. The folding cart frame according to claim 6, wherein a bottom end of the connecting member is provided with a connecting groove in a sunken manner, the connecting groove is sleeved on the first column or the second column and is fixedly connected relative to the first column or the second column through a fastener, outer surfaces of the first canopy column and the second canopy column are configured as cylindrical surfaces, and the first limiting surface is configured as a circular arc concave surface arranged corresponding to the first canopy column or the second canopy column.

8. The folding cart frame according to claim 1, wherein included angles between the bottom frame structure and the third side frame member and the fourth side frame member are greater than 90° respectively, the first side frame structure and the second side frame structure respectively comprise a first crossed rod group connected to the third side frame member and a second crossed rod group connected to the fourth side frame member, the first crossed rod group comprises a first crossed rod and a second crossed rod that are oppositely arranged in a crossing manner and that are rotatably connected with each other, the second crossed rod group comprises a third crossed rod and a fourth crossed rod that are oppositely arranged in a crossing manner and that are rotatably connected with each other, one end of the first crossed rod is rotatably connected to a lower portion of the third side frame member, the other end thereof is rotatably connected to one end of the fourth crossed rod, one end of the second crossed rod is rotatably connected to an upper portion of the third side frame member through a first connecting strip, the other end thereof is rotatably connected to one end of the third crossed rod, the other end of the third crossed rod is rotatably connected to an upper portion of the fourth side frame member through a second connecting strip, and the other end of the fourth crossed rod is rotatably connected to a lower portion of the fourth side frame member; and
a support rod is connected between two second crossed rods and/or two third crossed rods, the bottom frame structure comprises a first bottom frame member connected to the third side frame member and a second bottom frame member connected to the fourth side frame member, the first bottom frame member is rotatably connected to the second bottom frame member through a second connecting shaft, the second connecting shaft is arranged above the support rod, and the first bottom frame member and/or the second bottom frame member abut against an upper side of the support rod in the unfolded state.

9. The folding cart frame according to claim 1, wherein a handrail structure is mounted on one side, away from the third side frame member, on the fourth side frame member, and the handrail structure comprises a third column and a fourth column that are oppositely arranged and a handrail rod whose two ends are rotatably connected to the third column and the fourth column respectively through a locking assembly; and
the third column and the fourth column are respectively connected to the fourth side frame member through a second connecting structure, the second connecting structure comprises a mounting member that is fixedly connected relative to the fourth side frame member and a connecting cylinder connected to one side, away from the third side frame member, on the mounting member, the third column and the fourth column are respectively sleeved on a corresponding connecting cylinder and telescopically connected to the connecting cylinder, and the third column and the fourth column are respectively connected to the connecting cylinder in a positioning manner through a positioning assembly in the unfolded state.

10. A pet cart, comprising a folding cart frame according to claim 1 and a cloth cover structure covering a first side frame structure, a second side frame structure, a third side frame structure, and a fourth side frame structure, wherein
the cloth cover structure comprises a door cloth member arranged corresponding to the third side frame structure and/or the fourth side frame structure; and
the cloth cover structure is provided with a first visible region arranged among the first side frame structure, a first canopy frame member, and a second canopy frame member, and/or the cloth cover structure is provided with a second visible region arranged among the second side frame structure, the first canopy frame member, and the second canopy frame member, and/or the cloth cover structure is provided with a third visible region arranged corresponding to the third side frame structure, and/or the cloth cover structure is provided with a fourth visible region arranged corresponding to the fourth side frame structure.
